(19) United States
(12) Patent Application Publication
(10) Pub. No.: US 2016/0351147 A1
(43) Pub. Date: Dec. 1, 2016

(54) APPARATUS AND METHOD FOR DRIVING DISPLAY SUBSTRATE AND DISPLAY DEVICE

(71) Applicants: BOE TECHNOLOGY GROUP CO., LTD., Beijing (CN); HEFEI BOE OPTOELECTRONICS TECHNOLOGY CO., LTD., Anhui (CN)

(72) Inventors: Liangliang ZHENG, Beijing (CN); Tingting JIN, Beijing (CN)

(73) Assignees: BOE TECHNOLOGY GROUP CO., LTD., Beijing (CN); HEFEI BOE OPTOELECTRONICS TECHNOLOGY CO., LTD., Anhui (CN)

(21) Appl. No.: 15/166,104

(22) Filed: May 26, 2016

(30) Foreign Application Priority Data
May 26, 2015 (CN) 201510274951.2

(51) Int. Cl. G09G 3/36

(52) U.S. Cl. CPC G09G 3/3648; G09G 2310/0286; G09G 2330/021; G09G 2310/08; G09G 2360/18

(57) ABSTRACT

The present disclosure provides an apparatus for driving a display substrate, a method for driving a display substrate and a display device, the apparatus for driving a display substrate comprising: a comparator for comparing a received original display data with a pre-stored reference display data to generate a comparative result, a control signal generation unit for generating a control signal when the comparative result shows that the original display data is the same as the reference display data, the control signal being used for controlling pre-set functional units within the time sequence controller and the source driver to be into a standby state, and an output unit for outputting a pre-stored effective display data under a control of the control signal.

### CROSS-REFERENCE TO RELATED APPLICATION

The present application claims a priority of the Chinese patent application No.201510274951.2 filed on May 26, 2015, which is incorporated herein by reference in its entirety.

### TECHNICAL FIELD

The present disclosure relates to the field of display technique, and specifically relates to an apparatus and method for driving a display substrate and a display device.

### BACKGROUND

Along with the vigorous development of the semiconductor technology in recent years, portable electronic products and flat panel display products are rising with it. In addition, the thin film transistor (TFT) liquid crystal display has gradually become a standard output apparatus for various digital products due to its advantages such as a low operating voltage, free of scattering of radiation, a light weight and a small volume.

With a higher and higher system integration degree of various display devices such as a mobile phone, PAD and the like and a thinner and thinner thickness thereof, the CPU of a system successively evolves from the original single-core type to the dual-core type, the quad-core type and the eight-core type, and even the multi-core type product emerges on the market. The power consumption of the system is higher and higher, and the resolution of the display panel also is higher and higher. With an improvement of the resolution of the display panel, the power consumption of the display panel is remarkably enhanced. Meanwhile, there is a higher requirement for the battery lives of display devices such as a mobile phone and a PAD. Accordingly, how to continuously reduce the power consumption of a display device becomes the object that the system manufacturers and the panel manufacturers are pursuing.

### SUMMARY

The present disclosure provides an apparatus for driving a display substrate, a method for driving a display substrate and a display device, and thus, the power consumption of the display device can be effectively reduced.

The present disclosure provides the solutions as follows.

The embodiments of the present disclosure provide a display substrate driving device, which includes a time sequence controller and a source driver; a comparator for comparing a received original display data with a pre-stored reference display data to generate a comparative result; a control signal generation unit for generating a control signal when the comparative result shows that the original display data is the same as the reference display data, the control signal being used for controlling pre-set functional units within the time sequence controller and the source driver to be into a standby state; and an output unit for outputting the pre-stored effective display data under a control of the control signal.

Alternatively, the display substrate driving device comprises a buffer for storing a display data, the display data includes the reference display data and an effective display data, the comparator obtains the reference display data by reading the buffer, and the output unit obtains the effective display data by reading the buffer.

Alternatively, the comparator also is used for storing the original display data into the buffer after obtaining the comparative result so as to replace the reference display data.

Alternatively, the original display data and the reference display data are data displayed in continuous lines or spaced lines.

Alternatively, the control signal is used for controlling all the functional units within the time sequence controller and the source driver to be into a standby state.

Alternatively, the control signal is used for controlling parts of the functional units within the time sequence controller and the source driver to be into a standby state.

Alternatively, the time sequence controller includes a first receiver, a first data latch, a data processing unit and a data transmitter. The control signal is used for controlling the data processing unit and the data transmitter to be into a standby state. The original display data or the reference display data is a data processed by the first data latch.

Alternatively, the source driver comprises a second receiver, a shifting register, a second data latch, a level shift, a digital-to-analogue conversion unit and an output driving buffer. The control signal is used for controlling the second receiver, the shifting register and the second data latch to be into a standby state, or controlling the second receiver, the shifting register, the second data latch, the level shift and the digital-to-analogue conversion unit to be into a standby state. The effective display data is a data processed by the second data latch, or a data processed by the digital-to-analogue conversion unit. The output unit is used for outputting the effective display data to the level shift or the output driving buffer.

Alternatively, the comparator and the control signal generation unit are disposed in the time sequence controller. The output unit is disposed in the source driver.

Alternatively, the buffer comprises a first buffer for storing the reference display data, which is disposed within the time sequence controller, and a second buffer for storing the effective display data, which is disposed in the source driver.

The embodiments of the disclosure also provide a display substrate driving method, and it is used in a display substrate driving device, which includes a time sequence controller and a source driver. The method comprises: comparing a received original display data with a pre-stored reference display data to generate a comparative result; generating a control signal when the comparative result shows that the original display data is the same as the reference display data, the control signal being used for controlling pre-set functional units within the time sequence controller and the source driver to be into a standby state; and outputting a pre-stored effective display data under a control of the control signal.

Alternatively, prior to comparing the received original display data with the pre-stored reference display data to generate a comparative result, the method further includes storing the reference display data and the effective display data.

Alternatively, after comparing the received original display data with the pre-stored reference display data to generate a comparative result, the method further includes storing the original display data to replace a reference display data.

Alternatively, under a control of the control signal, the process of outputting an effective display data includes obtaining the effective display data by reading the stored display data.

Alternatively, the original display data and the reference display data are data displayed in continuous lines or spaced lines.

Alternatively, the control signal is used for controlling all the functional units within the time sequence controller and the source driver to be into a standby state.

Alternatively, the time sequence controller comprises a first receiver, a first data latch, a data processing unit and a data transmitter. The control signal is used for controlling the data processing unit and the data transmitter to be into a standby state. The original display data or the reference display data is a data processed by the first data latch.

Alternatively, the source driver comprises a second receiver, a shifting register, a second data latch, a level shift, a digital-to-analogue conversion unit and an output driving buffer. The control signal is used for controlling the second receiver, the shifting register and the second data latch to be into a standby state, or controlling the second receiver, the shifting register, the second data latch, the level shift and the digital-to-analogue conversion unit to be into a standby state. The effective display data is a data processed by the second data latch, or a data processed by the digital-to-analogue conversion unit. Under a control of the control signal, outputting an effective display data comprises outputting the effective display data to the level shift or the driving buffer.

The embodiments of the disclosure also provide a display device, which specifically comprises the apparatus for driving a display substrate provided by the embodiments of the present disclosure.

Regarding the apparatus for driving the display substrate, the method for driving the display substrate and the display device provided by the present disclosure, provided are the following components: a comparator for comparing a received original display data with a pre-stored reference display data to generate a comparative result, a control signal generation unit for generating a control signal when the comparative result shows that the original display data is the same as the reference display data, the control signal being used for controlling pre-set functional units within the time sequence controller and the source driver to be into a standby state; and an output unit for outputting the pre-stored effective display data under a control of the control signal. Accordingly, when there is a need for displaying an image data, a pre-set functional unit within a display device can be put into a standby state of not working in order to effectively reduce the power consumption of the display device.

### BRIEF DESCRIPTION OF THE DRAWINGS

FIG. 1 is a schematic view showing a structure of an apparatus for driving a display substrate according to at least one embodiment of the present disclosure.

FIG. 2 is a block diagram showing structures of a time sequence controller and a source driver.

FIG. 3 is another schematic view showing a structure of an apparatus for driving a display substrate according to at least one embodiment of the present disclosure.

FIG. 4 is yet another schematic view showing a structure of an apparatus for driving a display substrate according to at least one embodiment of the present disclosure.

FIG. 5 is still yet another schematic view showing a structure of an apparatus for driving a display substrate according to at least one embodiment of the present disclosure.

FIG. 6 is a schematic flow chart showing a method for driving a display substrate according to at least one embodiment of the present disclosure.

### DETAILED DESCRIPTION

The technical solutions of the present disclosure will be described clearly and completely hereinafter in conjunction with the drawings used in the embodiments so that the object, the technical solution and the advantages of the disclosed embodiments are much clearer. Obviously, the following embodiments merely relate to parts of, rather than all of, the described embodiments, and a person skilled in the art may obtain the other embodiments based thereon, which also fall within the scope of the present invention.

Unless defined otherwise, the technical terms or the scientific terms used hereinafter shall refer to general meanings understood by an ordinary skilled person in the technical field of the present disclosure. The terms “first” and “second” and similar expressions used in the description of the present application and the claims do not indicate any order, number or importance, but they are just used to differentiate different components. Likewise, similar expressions such as “a” or “one” do not indicate a limitation on the number, but just indicate that at least one is present. Similar expressions such as “connection” or “connected to each other” may include a direct or indirect electric connection rather than be limited to a physical or mechanical connection. The expressions “the previous”, “the next”, “left” and “right” only are used for indicating a relative position relation, and after an absolute position of a described object is changed, the relative position relation is changed correspondingly.

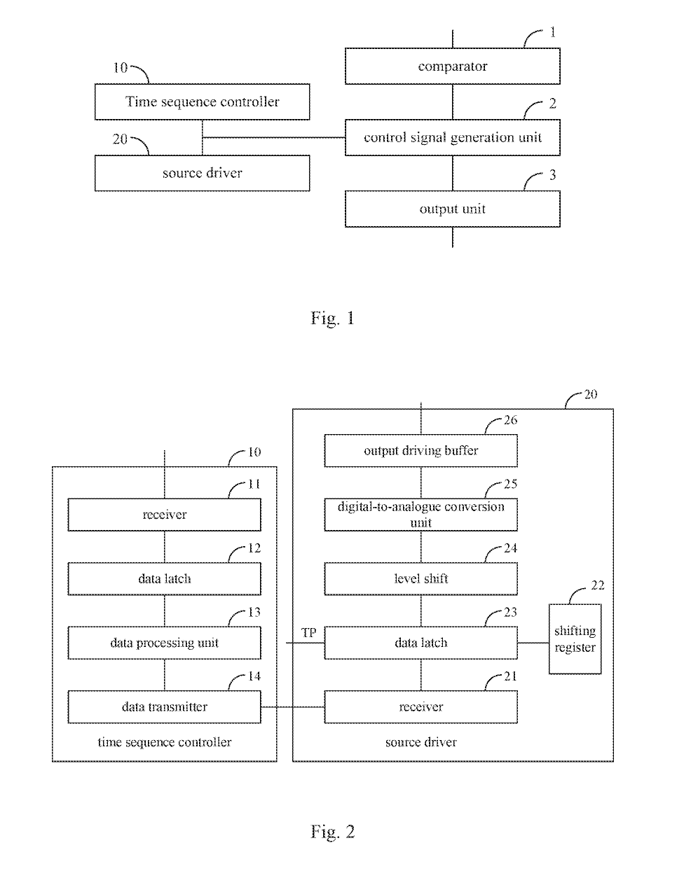

An embodiment of the present disclosure provides an apparatus for driving a display substrate, which comprises a time sequence controller 10 and a source driver 20. As shown in FIG. 1, the apparatus for driving a display substrate also includes: a comparator 1 for comparing a received original display data with a pre-stored reference display data to generate a comparative result; a control signal generation unit 2 for generating a control signal when the comparative result shows that the original display data is the same as the reference display data, the control signal being used for controlling pre-set functional units within the time sequence controller 10 and the source driver 20 to be into a standby state; and an output unit 3 for outputting a pre-stored effective display data under a control of the control signal.

In a related art, a display substrate driving circuit can be shown in FIG. 2. A receiver 11 within a time sequence controller 10 (i.e. a time sequence control chip, TCON) decodes the received image data according to a specific protocol. For example, protocol conversions are performed on signals of the mobile industry processor interface (MIPI), low voltage differential signals (LVDS) and signals of a high definition digital display internal interface (eDP), the corresponding image information is extracted, i.e. a data is displayed, and it is written into a data latch 12 of the time sequence controller 10 in a specific order. A data processing unit 13 within the time sequence controller 10 performs an image information process according to a pre-configured gamma, contrast enhancement (CE) and self-adaptive backlight control (CABC) algorithm of image content. After a data transmitter 14 within the time sequence controller 10 performs specific protocol encoding on the processed image, and transmitting the same a source driver 20 (i.e. a source driver chip, SOURCE). For example, a display data is packed into mini low voltage differential signals (mini LVDS) and P2P signals. A receiver 21 of the source driver 20 decodes the received image information according to a specific protocol, extracts the corresponding image information, and writes the information into a data latch 23 of the source driver 20 according to a specific order in cooperation with trigger pulse (TP) signals and signals of a shift register 22. A level shift 24 within the source driver 20 converts a low voltage digital signal within the data latch 23 into a medium voltage digital signal referring to gamma voltage. A digital-to-analogue conversion unit 25 within the source driver 20 converts the medium voltage digital signal into an analog signal which is to be transmitted to a driving buffer 26 so that the analog signal is transmitted to a display panel for realizing image display.

No matter whether data displayed in continuous lines and data displayed in spaced lines are the same, a display substrate driving circuit in the related art will perform processing on the data displayed in each line according to the above display data processing flow so that the power consumption of a display device cannot be reduced at a driving end.

The apparatus for driving a display substrate provided in an embodiment of the disclosure, during an analysis and a processing on the original display data, can put all or a part functional units of the time sequence controller 10 and the source driver 20 within the apparatus into a standby state of not working when the original display data and the pre-stored reference display data are the same. In other words, the corresponding display data processing function is performed without consuming the power of the functional units within the time sequence controller 10 and the source driver 20, and instead, the pre-stored effective display data is output so as to reduce the power consumption of the apparatus for driving a display substrate and the display device.

The original display data specifically can be a display data that is not processed or is processed by some function unit(s) within the time sequence controller 10.

The reference display data specifically can be a pre-selected display data such as a all black or all white display data. The reference display data might be a display data that is continuous with the original display data or has a predetermined interval with the original display data. For example, when the original display data is a display data in the next line, the reference display data can be a display data in the current line or a display data in the previous line. That is, in at least one embodiment of the present disclosure, the original display data and the reference display data specifically can be the display data in continuous lines or the display data in spaced lines.

The effective display data can be a display data that can be directly output to a display substrate for realizing displaying after being processed by the source driver 20, or can be a display data processed by a certain functional unit in the source driver 20. For example, the effective display data in the previous line is generated after the original display data in the previous line is processed by the time sequence controller 10 and the source driver 20.

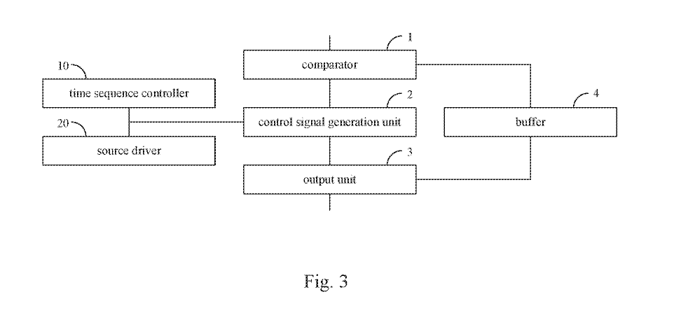

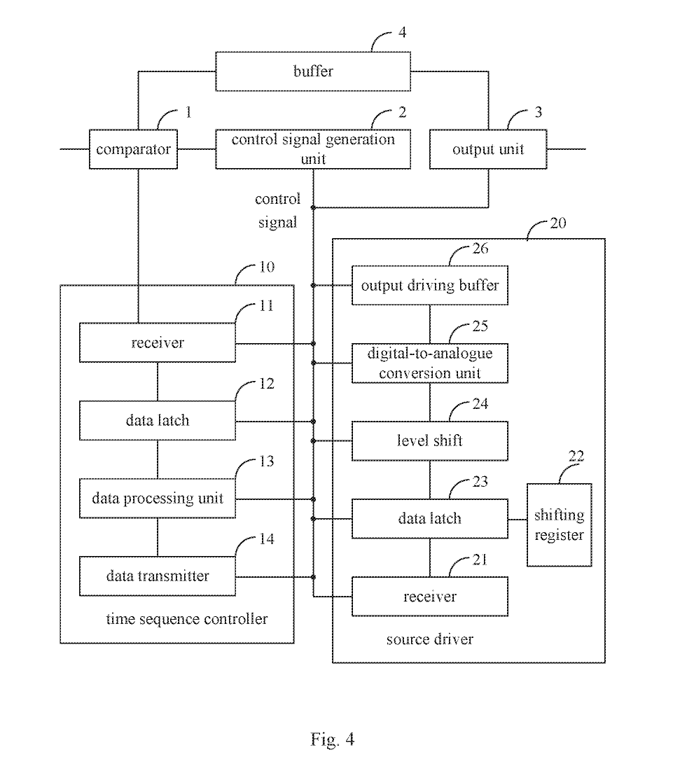

In one embodiment of the present disclosure, FIG. 3 shows that, for realizing storing the display data, the apparatus for driving a display substrate can be provided therein with a buffer 4 for storing a display data.

The display data stored in the buffer 4 specifically can be a reference display data, an effective display data and the like. In one embodiment of the present disclosure, the display data stored in the buffer 4 can be the display data itself or identification information such as the identifier of the display data so that devices such as a comparator 1 can perform the corresponding processing based on the display data itself or the identification information such as the identifier of the display data.

The time sequence controller 10 and the source driver 20 in the related art may be used in the embodiments of the present disclosure. That is, the time sequence controller 10 specifically can be provided therein with functional units such as a receiver 11, a data latch 12, a data processing unit 13 and a data transmitter 14, and the source driver 20 can be specifically provided therein with functional units such as a receiver 21, a shifting register 22, a data latch 23, a level shift 24, a digital-to-analogue conversion unit 25 and an output driving buffer 26.

In the specific embodiments of the present disclosure, as shown in FIG. 4, the control signal generated by the control signal generation unit 2 specifically can be used for controlling both the time sequence controller 10 and the source driver 20 to be into a standby state of not working on the whole. That is, all the functional units in the time sequence controller 10 and the source driver 20 will not perform the corresponding display data processing operation so as to reduce the power consumptions of the apparatus for driving a display substrate and the display device.

Then, in this embodiment, the comparator 1, the control signal generation unit 2, the display signal output unit 3 and the buffer 4 can be individually disposed in the apparatus for driving a display substrate, and can realize an electric connection shown in FIGS. 1 and 4.

In this embodiment, as shown in FIG. 4, the comparator 1 receives the original display data (i.e. the original display data in the next line) and obtains the pre-stored reference display data by reading the buffer 4 (such as the original display data in the current line or in the previous line) to compare the two.

When a comparative result shows that the original display data is different from the reference display data, the comparator 1 transmits the received original display data to the time sequence controller 10 (it specifically can be a receiver 11) and can perform a displaying data process according to a conventional display data processing flow. Thus, details are not repeated here.

When the comparative result shows that the original display data is the same as the reference display data, the comparator 1 transmits a trigger signal to the control signal generation unit 2 so that the control signal generation unit 2 can generate a control signal, which put all the functional units within both the time sequence controller 10 and the source driver 20 into a standby state of not working so as to reduce the power consumption of the display device.

The comparator 1 also stores the obtained original display data into the buffer 4 to replace the reference display data pre-stored in the buffer 4 for facilitating a subsequent comparison of the display data.

The control signal generated by the control signal generation unit 2 also can be used for triggering the output unit 3 to transmit an effective display data to a display substrate.

Specifically, the effective display data can be a display data that enables a normal display of the display substrate after being processed by the time sequence controller 10 and the source driver 20. Besides, the effective display data is synchronously stored in the buffer 4 after it is generated or output to the display substrate. When the output unit 3 receives the control signal, it reads the buffer 4 to obtain the effective display data and output it to the display substrate.

In at least one embodiment of the present disclosure, the control signal generated by the control signal generation unit 2 specifically can be used for controlling parts of the functional units of both the time sequence controller 10 and the source driver 20 to be into a standby state of not working.

In this embodiment, the original display data and the reference display data specifically can be a display data processed by a certain functional unit within the time sequence controller 10 such as the display data processed by a data latch 12, a data processing unit 13 and the like, and the effective display data can be a display data processed by a certain functional unit within the source driver 20 such as the data processed by a certain functional unit among a shift register 22, a data latch 23, a level shift 24 and a digital-to-analogue conversion unit 25.

In this embodiment, the comparator 1 and the control signal generation unit 2 specifically can be disposed within the time sequence controller 10. The comparator 1 is used for receiving the original display data processed by a certain functional unit among a receiver 11, a data latch 12 and a data processing unit 13, and obtains a reference display data stored in the buffer 4 for comparing them.

When the original display data is the same as the reference display data, the comparator 1 triggers the control signal generation unit 2 to generate a control signal, and the control signal generation unit 2 transmits the control signal to parts of the functional units of the time sequence controller 10 and the source driver 20 so that the corresponding functional units can be in a standby state. Meanwhile, the control signal can be used for triggering the output unit 3 to output the effective display data to a certain functional unit in the source driver 20 or the display substrate. However, when the original display data is different from the reference display data, the comparator 1 transmits the original display data to the subsequent functional units such as a data processing unit 13 for performing a conventional display data processing. Besides, the comparator 1 can store the original display data into the buffer 4 to realize replacement of the reference display data.

In this embodiment, the output unit 3 specifically can be disposed in the source driver 20.

The related display data in the time sequence controller 10 and the source driver 20 respectively correspond to the original display data, the reference display data and the effective display data that require being stored. Therefore, the buffer 4 comprises a first buffer 41 and a second buffer 42.

The first buffer 41 is used for storing the reference display data, and can be disposed in the time sequence controller 10.

The second buffer 42 is used for storing the effective display data, and can be disposed in the source driver 20.

The process of realizing this embodiment will be hereinafter described in detail.

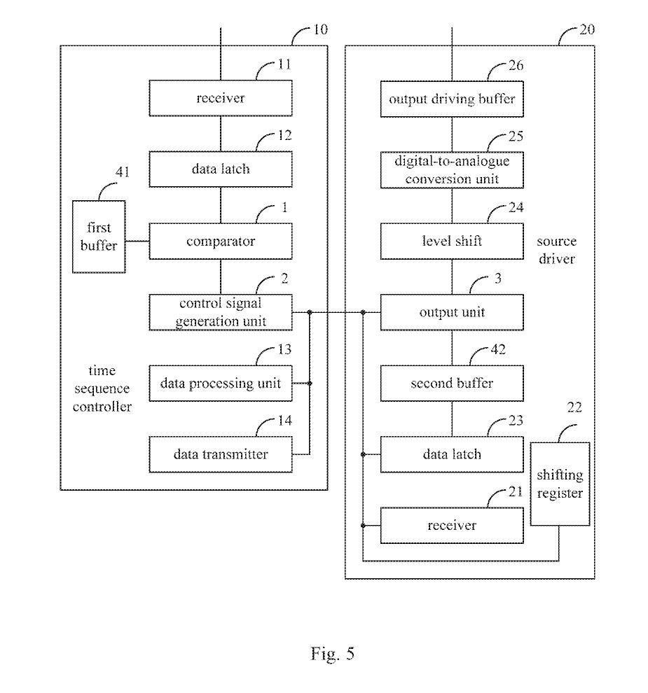

In this embodiment, as shown in FIG. 5, the comparator 1 is disposed in the time sequence controller 10, and receives the original display data and the reference display data that are processed by the data latch 12. The control signal generation unit 2 is also disposed in the time sequence controller 10, and performs a communication connection with the comparator 1. The output unit 3 is disposed in the source driver 20 and used for transmitting the pre-stored effective display data to the level shift 24. The first buffer 41 is disposed in the time sequence controller 10 and used for storing the original display data and the reference display data. The second buffer 42 is disposed in the source driver 20 and used for storing the effective display data.

The process for realizing the embodiment is as follows.

A receiver 11 receives the original display data (such as the original display data in the next line) and decodes the received original data according to a specific protocol. For example, protocol conversions are performed on signals of a mobile industry processor interface (MIPI), low voltage differential signals (LVDS) and signals of a high definition digital display internal interface (eDP), the corresponding display data is extracted and is written into a data latch 12 of the time sequence controller 10 in accordance with a specific order.

The comparator 1 respectively obtains the original display data in the data latch 12 (it specifically can be the original display data in the next line) and the reference display data pre-stored in the first buffer 41 (the reference display data specifically can be the original display data in the current line or the previous line which is processed by the data latch 12), and compares the two to obtain a comparative result.

When the comparative result shows that the original display data is the same as the reference display data, the comparator 1 triggers the control signal generation unit 2 to generate a control signal.

When the comparative result shows that the original display data is different from the reference display data, the comparator 1 transmits the original display data to a data processing unit 13, and a conventional display data processing is performed afterwards.

After obtaining the corresponding comparative result, the comparator 1 can store the original display data into the first buffer 41 to realize replacement of the reference display data for facilitating a comparison of the subsequent display data.

The control signal generation unit 2 synchronously transmits the generated control signal to the data processing unit 13 and the data transmitter 14 in the time sequence controller 10 and the receiver 21, the shift register 22 and the data latch 23 in the source driver 20 so that those functional units are put into a standby state of not working. Meanwhile, the control signal generation unit 2 can transmit the control signal to an output unit 3 so that the output unit 3 can read the second buffer 42 in the source driver 20 to obtain effective display data (this effective display data specifically can be the effective display data in the current line or the previous line which is processed by the data latch 23) and transmit the effective display data to a level shift 24. The level shift 24 converts the effective display data (i.e. a low voltage digital signal) into a medium voltage digital signal referring to gamma voltage. Then, a digital-to-analogue conversion unit 25 converts the medium voltage digital signal into an analog signal which is to be transmitted to a driving buffer 26 in order to finally deliver the analog signal to a display substrate for realizing image display.

Then, it is clear that in this embodiment, if the original display data and the reference display data are the same, the data processing unit 13 and the data transmitter 14 in the time sequence controller 10 and the receiver 21, the shift register 22 and the data latch 23 in the source driver 20 can be put into a standby state of not working so as to reduce the power consumption of the display device.

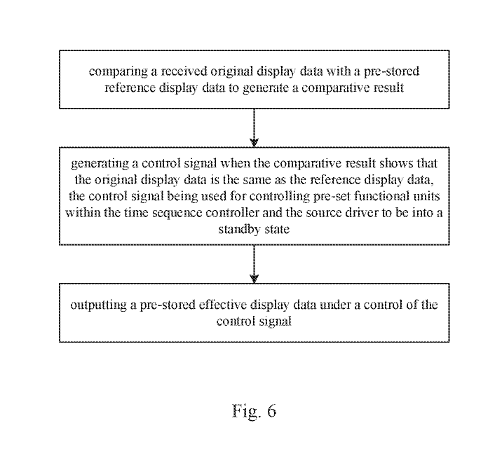

The embodiments of the present disclosure provide a method for driving a display substrate, which can be specifically used in the apparatus for driving a display substrate provided by the above embodiment. As shown in FIG. 6, the method specifically includes: comparing a received original display data with a pre-stored reference display data to generate a comparative result; generating a control signal when the comparative result shows that the original display data is the same as the reference display data, the control signal being used for controlling pre-set functional units within the time sequence controller and the source driver to be into a standby state; and outputting a pre-stored effective display data under a control of the control signal.

In a specific embodiment, prior to comparing the received original display data with the pre-stored reference display data to generate a comparative result, the method further includes: storing a reference display data and an effective display data.

After comparing the received original display data with the pre-stored reference display data to generate a comparative result, the method further includes: storing the original display data to realize replacement of the reference display data.

Under the control of the control signal, the step of outputting an effective display data includes obtaining the effective display data by reading the stored display data.

In a specific embodiment, the original display data and the reference display data related to the method are display data in continuous lines or spaced lines.

In a specific embodiment, the time sequence controller 10 related to this method, as shown in FIGS. 4 and 5, includes a receiver 11, a data latch 12, a data processing unit 13 and a data transmitter 14.

Then, the control signal can control the data processing unit 13 and the data transmitter 14 to be into a standby state.

In addition, in this embodiment, the original display data or the reference display data is a data processed by the data latch 12.

In a specific embodiment, the source driver 20 related to this method, as shown in FIGS. 4 and 5, includes a receiver 21, a shifting register 22, a data latch 23, a level shift 24, a digital-to-analogue conversion unit 25 and an output driving buffer 26.

Then, the control signal can be used for controlling the receiver 21, the shifting register 22 and the data latch 23 to be into a standby state, or can be used for controlling the receiver 21, the shifting register 22, the data latch 23, the level shift 24 and the digital-to-analogue conversion unit 25 to be into standby states.

In this embodiment, the effective display data specifically can be a data processed by the data latch 23, or can be a data processed by the digital-to-analogue conversion unit 25.

Under a control of the control signal, the process of outputting an effective display data may include: outputting the effective display data to the level shift 24 or the output driving buffer 26.

The embodiments of the disclosure also provide a display device, which specifically includes the apparatus for driving a display substrate provided by the embodiment of the disclosure.

The above are merely the preferred embodiments of the present invention. It should be noted that, a person skilled in the art may make further modifications and improvements to the present invention without departing from the principle of the present invention, and these modifications and improvements shall also be considered as the scope of the present invention.

What is claimed is:

1. An apparatus for driving a display substrate, comprising:
a time sequence controller and a source driver:
a comparator for comparing a received original display data with a pre-stored reference display data to generate a comparative result;
a control signal generation unit for generating a control signal when the comparative result shows that the original display data is the same as the reference display data, the control signal being used for controlling pre-set functional units within the time sequence controller and the source driver to be into a standby state; and
an output unit for outputting a pre-stored effective display data under a control of the control signal.

2. The apparatus according to claim 1, further comprising a buffer for storing a display data, wherein the display data comprises the reference display data and an effective display data,
the comparator obtains the reference display data by reading the buffer, and
the output unit obtains the effective display data by reading the buffer.

3. The apparatus according to claim 2, wherein the comparator also is used for storing the original display data into the buffer after obtaining the comparative result so as to replace the reference display data.

4. The apparatus according to claim 1, wherein the original display data and the reference display data are data displayed in continuous lines or spaced lines.

5. The apparatus according to claim 1, wherein the control signal is used for controlling all functional units in the time sequence controller and the source driver to be into a standby state.

6. The apparatus according to claim 1, wherein the control signal is used for controlling parts of the functional units in the time sequence controller and the source driver to be into a standby state.

7. The apparatus according to claim 1, wherein the time sequence controller comprises a first receiver, a first data latch, a data processing unit and a data transmitter,
the control signal is used for controlling the data processing unit and the data transmitter to be into a standby state, and
the original display data or the reference display data is a data processed by the first data latch.

8. The apparatus according to claim 1, wherein the source driver comprises a second receiver, a shifting register, a second data latch, a level shift, a digital-to-analogue conversion unit and an output driving buffer,
the control signal is used for controlling the second receiver, the shifting register and the second data latch to be into a standby state or controlling the second receiver, the shifting register, the second data latch, the level shift and the digital-to-analogue conversion unit to be into a standby state,
the effective display data is a data processed by the second data latch, or a data processed by the digital-to-analogue conversion unit, and
the output unit is used for outputting the effective display data to the level shift or the output driving buffer.

9. The apparatus according to claim 1, wherein the comparator and the control signal generation unit are disposed in the time sequence controller, and the output unit is disposed in the source driver.

10. The apparatus according to claim 1, wherein the buffer comprises:
a first buffer for storing the reference display data and being disposed within a time sequence controller, and
a second buffer for storing the effective display data and being disposed in a source driver.

11. A method for driving a display substrate, being used in an apparatus for driving a display substrate the apparatus comprising a time sequence controller and a source driver, wherein:
the method comprises:
comparing a received original display data with a pre-stored reference display data to generate a comparative result;
generating a control signal when the comparative result shows that the original display data is the same as the reference display data, the control signal being used for controlling pre-set functional units within the time sequence controller and the source driver to be into a standby state; and
outputting a pre-stored effective display data under a control of the control signal.

12. The method according to claim 11, wherein prior to comparing the received original display data with the pre-stored reference display data to generate the comparative result, the method further comprises storing the reference display data and the effective display data.

13. The method according to claim 11, wherein after comparing the received original display data with the pre-stored reference display data to generate the comparative result, the method further comprises storing the original display data to replace the reference display data.

14. The method according to claim 11, wherein outputting the effective display data under the control of the control signal further comprises obtaining the effective display data by reading the stored display data under the control of the control signal.

15. The method according to claim 11, wherein the original display data and the reference display data are data displayed in continuous lines or spaced lines.

16. The method according to claim 11, wherein the control signal is used for controlling all functional units within the time sequence controller and the source driver to be into a standby state.

17. The method according to claim 11, wherein the control signal is used for controlling parts of the functional units within the time sequence controller and the source driver to be into a standby state.

18. The method according to claim 11, wherein the time sequence controller comprises a first receiver, a first data latch, a data processing unit and a data transmitter,
the control signal is used for controlling the data processing unit and the data transmitter to be into a standby state, and
the original display data or the reference display data is a data processed by the first data latch.

19. The method according to claim 11, wherein the source driver comprises a second receiver, a shifting register, a second data latch, a level shift, a digital-to-analogue conversion unit and an output driving buffer,
the control signal is used for controlling the second receiver, the shifting register and the second data latch to be into a standby state, or controlling the second receiver, the shifting register, the second data latch, the level shift and the digital-to-analogue conversion unit to be into a standby state,
the effective display data is a data processed by the second data latch, or a data processed by the digital-to-analogue conversion unit,
outputting the effective display data under the control of the control signal comprises outputting the effective display data to the level shift or the driving buffer.

20. A display device, comprising an apparatus for driving a display substrate according to claim 1.
